(19) United States
(12) Patent Application Publication
(10) Pub. No.: US 2006/0137025 A1
(43) Pub. Date: Jun. 22, 2006

(54) Method for restriction of access to at least one content, computer program product and corresponding receiver device

(75) Inventors: Pascal Lagrange, Rennes (FR); Jean-Paul Accarie, Vern Sur Seiche (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Amsterlveen (NL)

(21) Appl. No.: 11/282,776

(22) Filed: Nov. 21, 2005

(30) Foreign Application Priority Data
Dec. 17, 2004 (FR) 04 13534

(51) Int. Cl. H04L 9/32

(52) U.S. Cl. 726/27

(57) ABSTRACT

In a method for the restriction of access from a sink device to a content stored in a storage device, a content protection protocol comprises an authentication phase and an encryption key exchange phase is implemented between the storage device and the sink device. The method comprises a prior step for the association of at least one predetermined password with said content and/or said storage device; and the following steps of: a) obtaining at least one piece of access information during the authentication phase; b) obtaining a processing function dependent on said at least one piece of access information (UCPK) and said at least one predetermined password (CPK); c) applying the processing function thus obtained during the authentication phase of the protection protocol, the application of the processing function causing the authentication phase to fail when said at least one piece of access information does not meet a predetermined condition.

### 1. FIELD OF THE INVENTION

The field of the invention is that of data communications networks. More particularly the invention relates to the restriction of access to contents, especially but not exclusively isochronous data stored in storage units in such a network.

There are known communications networks today to which there are connected various apparatuses generating and/or receiving isochronous data contents, and units (such as external hard disk drives) to store these contents.

The invention can be applied especially but not exclusively in the case of a multimedia network where the isochronous data stream conveys audio-video (AV) type data.

### 2. DESCRIPTION OF THE RELATED ART

The modern equipment that a family may install is often designed to transmit different types of data such as video, sound, photographs, text files and so on. The transmission of this data is governed by requirements that can vary according to the type of data considered. In particular, this data must be conveyed by means of cables or adapted links. Thus, each data format has a corresponding adapted means of transportation and a type of connector by which the devices are connected to each other. For example, devices processing digital data may work according to the IEEE-1394 standard.

The invention can be applied especially but not exclusively to an audio-video network, for example a home network comprising a backbone network, itself comprising nodes. The nodes have items of equipment or devices connected to them, directly through analog links or indirectly, for example, through serial digital buses compliant with the IEEE-1394 standard. It may be recalled that this standard is described in the following reference documents: “IEEE Std 1394-1995, Standard for High Performance Serial Bus” and “IEEE Std 1394a-2000, Standard for High Performance Serial Bus (Supplement)”.

FIG. 1A illustrates an example of an audio-video home network 1000 of this kind. This home network 1000 comprises a backbone network 1001, itself comprising nodes 003, 004, 005 interconnected through a central switching unit 015.

As can be seen in FIG. 1B, the central switching unit 015 has several switching devices 150a, 150b, 150c and 150d. For the sake of simplicity, FIG. 1B shows a switching unit 015 such as this comprising only four switching devices, 150a, 150b, 150c and 150d.

The switching device 150a is connected by means of a cable 153a to the switching device 150d. It is also connected by means of another cable 153d to the switching device 150c which is itself connected by another link 153e to the switching device 150d.

The switching device 150c is connected to the switching device 150b by means of a link 153c and finally the switching device 150b is connected to the switching device 150a by means of a communications link 153b.

It must be noted that the switching devices 150a, 150b, 150c and 150d are inserted in the partition walls of a dwelling. The device 150a is placed, for example, in the partition wall 152a of a room such as a living room, the device 150b in the partition wall 152b of another room such as the kitchen, the device 150c in the partition wall 120c of a room such as a study, and the device 150d in the partition wall 152d of a bedroom.

However, the switching devices 150a, 150b, 150c and 150d may be independent of the partition walls and may thus be movable.

The switching devices 150a, 150b and 150c (FIG. 1B) are connected to the nodes 003, 004 and 005 (referenced NA, NB and NC respectively in FIG. 1A) of the backbone network 1001 by means of a single medium, in this case cables 151a, 151b and 151c.

Furthermore, as can be seen in FIG. 1A, the node 003 is also connected to terminal devices:
a television set 014, a DVD player 013 and a VHS videocassette player 012 through analog links;
an audio-video hard disk drive 006, a VHS digital videocassette player 007 and an IEEE-1394 compliant digital DVD player 008 by means of an IEEE-1394 digital series bus 001.

The node 004 is connected through an IEEE-1394 002 digital series bus to a digital television set 009, a digital VHS videocassette recorder 010 and an IEEE-1394 tuner 011.

In a network, such as the home network 1000 of FIG. 1A, the contents stored in storage units connected to the network by IEEE 1394 buses need to be protected when these contents are transmitted from the storage unit to the network.

A known technique used to guarantee copy protection for isochronous streams (such as audio-video contents) during their transmission in a home network lies in the implementation of the DTCP (“Digital Transfer Content Protection”) protocol. The characteristics and recommendations of this protocol are described in detail in the following reference document: “Digital Transmission Content Protection Specification, Volume 1 and 2, Draft 1.29”.

The DTCP protocol provides that, during the transmission of a content from a “source device” (according to DTCP terminology) such as a storage device (for example a storage unit), to a receiver device or “sink device” according to DTCP terminology, the storage unit encrypts the data before transmitting it to the sink device, and the receiver device cannot decrypt this data unless it is preliminarily authenticated with the storage unit.

In the context of a content protection protocol such as the DTCP protocol, it may also be useful to be able to restrict access to the contents stored in the storage unit to certain users and/or receiver or sink devices.

A prior art access restriction technique is presented in the international patent application No WO2004015579 (belonging to the firm TREK 2000 INTERNAT LTD). This technique proposes to make access by a user to a storage unit conditional on the furnishing by this user of a predetermined password. The password given by the user is verified by means of an authentication algorithm implemented by a specific authentication system comprising storage means, a ROM and a microcontroller.

It can easily be seen that the juxtaposition of this known access restriction mechanism with a DTCP-type known mechanism for the copy protection of this content is not optimal. Indeed, this juxtaposition entails a large number of steps managed by one or more software programs, and hence an overload on the network in which it is implemented and substantial time for transmitting the contents in this network.

Furthermore, this large number of steps and transmitted messages makes the working of the network complex, increases its load, and hence reduces its processing speed.

Another problem related to this type of authentication is that, if the authentication fails, the connection between the source device and the sink device is not made. If the user wishes to maintain the connection between the source device and the sink device, for example to view a content of this unprotected source, he cannot do so with this prior art system.

### 3. GOALS OF THE INVENTION

It is a goal of the invention especially to mitigate these different drawbacks of the prior art.

More specifically, one of the goals of the present invention, in at least one embodiment, is to provide an improved technique for the restriction of access from a sink device to a content stored in a storage device when the two devices implement a content protection protocol (for example the DTCP).

It is also a goal of the invention, at least in one embodiment, to provide a technique of this kind that performs better than the above-mentioned juxtaposition of prior art mechanisms.

Yet another goal of the invention, in at least one embodiment, is to provide a reliable, easily implemented and low-cost technique of this kind.

It is also a goal of the invention to keep a valid connection between a source device and a sink device even if the content is not accessible to the sink device.

Yet another goal of the invention, in at least one embodiment, is to require no modification of the storage units already capable of implementing the content protection protocol (such as the DTCP).

### 4. ESSENTIAL CHARACTERISTICS OF THE INVENTION

These different goals, as well as others there shall appear here below, are achieved according to the invention by means of a method for the restriction of access from a sink device to a content stored in a storage device, a content protection protocol comprising an authentication phase and an encryption key exchange phase being implemented between the storage device and the sink device.

According to the invention, such a method comprises a prior step for the association of at least one predetermined password with said content and/or said storage device; and the following steps of:
a) obtaining at least one piece of access information during the authentication phase;
b) obtaining a processing function dependent on said at least one piece of access information and said at least one predetermined password;
c) applying the processing function thus obtained during the authentication phase of the protection protocol, the application of the processing function causing the authentication phase to fail when said at least one piece of access information does not meet a predetermined condition.

The general principle of the invention therefore consists in bringing the internal mechanism of a content protection protocol (for example the DTCP) into play to obtain the failure or non-failure of an authentication stipulated in this protocol so as to integrate an access restriction mechanism into this protection protocol.

Thus all the advantages of the protection protocol are obtained, without necessitating any specific authentication system (such as those proposed in the above-cited international patent application No WO2004015579) in the (source and sink) devices involved. The invention is even transparent to the storage device.

It is also important to note that, since the invention does not call for any sending of an additional message (other than those laid down in the content protection protocol), it does not in any way modify the load of the communications network to which the concerned (source and sink) devices belong.

Advantageously, the application of the processing function is done during the exchange of a message from the sink device to the storage de vice, the message being corrupted or tampered with if said at least one piece of access information does not comply with a predetermined condition.

According to a first advantageous embodiment of the invention, said at least one predetermined password is associated solely with said content and/or solely with said storage device.

Thus, the access to each content or storage device can be restricted individually.

According to a second advantageous embodiment of the invention, said at least one predetermined password is associated with a plurality of contents, to which said content belongs, and/or a plurality of storage devices, to which said storage device belongs.

Thus, it is possible to restrict access to groups or categories of contents or storage devices.

Advantageously, said at least one piece of access information is a user password.

According to a preferred characteristic of the invention, said predetermined condition is a correspondence between the user password and the predetermined password.

Thus, for example, the predetermined condition is met if the user password is identical to the predetermined password.

Preferably, the access restriction method comprises the following preliminary step:
the association of a first group of authorized devices, comprising at least one device authorized to access said content and/or said storage device;
and said at least one access condition is the identifier of the sink device.

According to a first mode of implementation of the invention, said predetermined access condition is the membership of said sink device in said first group of authorized devices.

According to a second mode of implementation of the invention, said predetermined access condition is both the membership of said sink device in said first group of authorized devices and a correspondence between the user password and the predetermined password.

Thus, a dual access-restriction technique is obtained, relating to both the sink devices and the users.

Advantageously, said sink device is an intermediate sink device forming a first node by which said storage device is connected to a communications network, a final requesting device is connected to said network through a second node, and the access to the content stored in the storage device is requested by said final requesting device, through said first and second nodes.

Preferably, said content protection protocol is the DTCP protocol.

The invention also relates to a computer program product comprising program code instructions for the execution of the steps of the method as described here above, when said program is executed on a computer.

The invention also relates to a storage means, which may be totally or partially removable and is readable by a computer, storing a set of instructions that can be executed by said computer to implement the method as described here above.

The invention also relates to a sink device enabling access to a content stored in a storage device, said sink device and said storage device comprising means to implement a content protection protocol, comprising an authentication phase and an encryption key exchange phase, said sink device comprising:
means to obtain at least one piece of access information during the authentication phase
means to obtain a processing function dependent on said at least one piece of access information and at least one predetermined password preliminarily associated with said content and/or said storage device;
means to apply the processing function thus obtained during the authentication phase of the protection protocol, the means for the application of the processing function causing the authentication phase to fail when said at least one piece of access information does not meet a predetermined condition.

Preferably, said means for the application of the processing function are activated during the exchange of a message between the sink device and the storage device, the message being corrupted or tampered with if at least one piece of access information does not meet a predetermined condition.

According to a first advantageous embodiment of the invention, said at least one predetermined password is associated solely with said content and/or solely with said storage device.

According to a second advantageous embodiment of the invention, said at least one predetermined password is associated with a plurality of contents, to which said content belongs, and/or a plurality of storage devices, to which said storage device belongs.

Preferably, said at least one piece of access information is a user password.

Advantageously, said predetermined condition is a correspondence between the user password and the predetermined password.

According to an advantageous characteristic of the invention, the sink device comprises:
means for the association of a first group of authorized devices, comprising at least one device authorized to access said content and/or said storage device;
   and said at least one access condition is the identifier of the sink device.

According to a first mode of implementation of the invention, said predetermined access condition is the membership of said sink device in said first group of authorized devices.

According to a second mode of implementation of the invention, said predetermined access condition is both the membership of said sink device in said first group of authorized devices and a correspondence between the user password and the predetermined password.

According to a preferred characteristic of the invention, the sink device is an intermediate sink device forming a first node by which said storage device is connected to a communications network,

and the sink device comprises means of communication with a second node by which a final requesting device is connected to said network, so that the access to the content stored in the storage device is requested by said final requesting device through said first and second nodes.

Advantageously, said content protection protocol is the DTCP protocol.

### 5. LIST OF FIGURES

Other features and advantages of the invention shall appear from the following description of two particular embodiments of the invention, given by way of an indicative and non-exhaustive example, and from the appended drawings, of which:

FIG. 1A is a drawing of an example of a home audio-video network in which a first preferred embodiment of the method according to the invention can be implemented;

FIG. 1B illustrates an example of an embodiment of the central switching unit of the home network of FIG. 1;

FIG. 1C is a drawing of an implementation of a node 100 of the home network 1000 according to a particular mode of implementation of the invention;

FIGS. 2A to 2D illustrates two examples of embodiments of the user graphic interface implemented in the first preferred embodiment of the access restriction method according to the invention;

FIG. 3 illustrates the first preferred embodiment of the access restriction method of the invention relying on the prior art DTCP protection protocol;

FIG. 4 is a flow chart of a first example of a key management algorithm, executed by a storage management node, in the first preferred embodiment of the access restriction method of the invention;

FIG. 5 is a flow chart of an example of a corruption or tampering algorithm for the authentication phase of the DTCP protocol executed by the receiver node or sink node (NA) in the first preferred embodiment of the access restriction method according to the invention;

FIG. 6 illustrates the general principle of a second particular embodiment of the access restriction method according to the invention;

FIG. 7 is a flow chart of a second example of a key management algorithm, executed by a storage management node in the second particular embodiment of the access restriction method according to the invention.

### 6. DESCRIPTION OF TWO EMBODIMENTS OF THE INVENTION

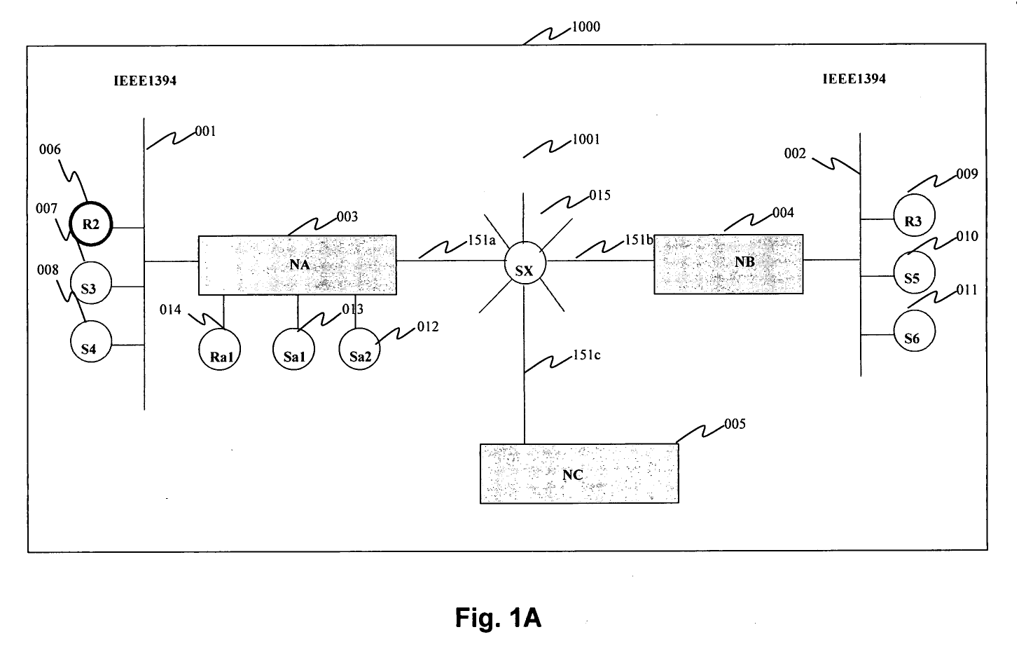

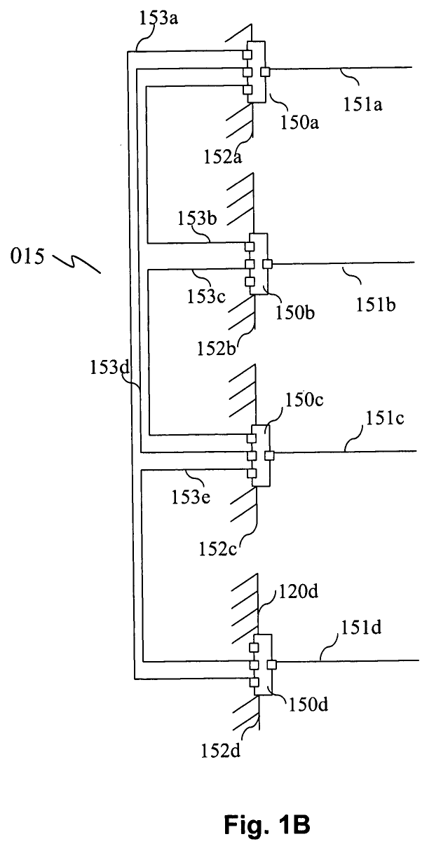

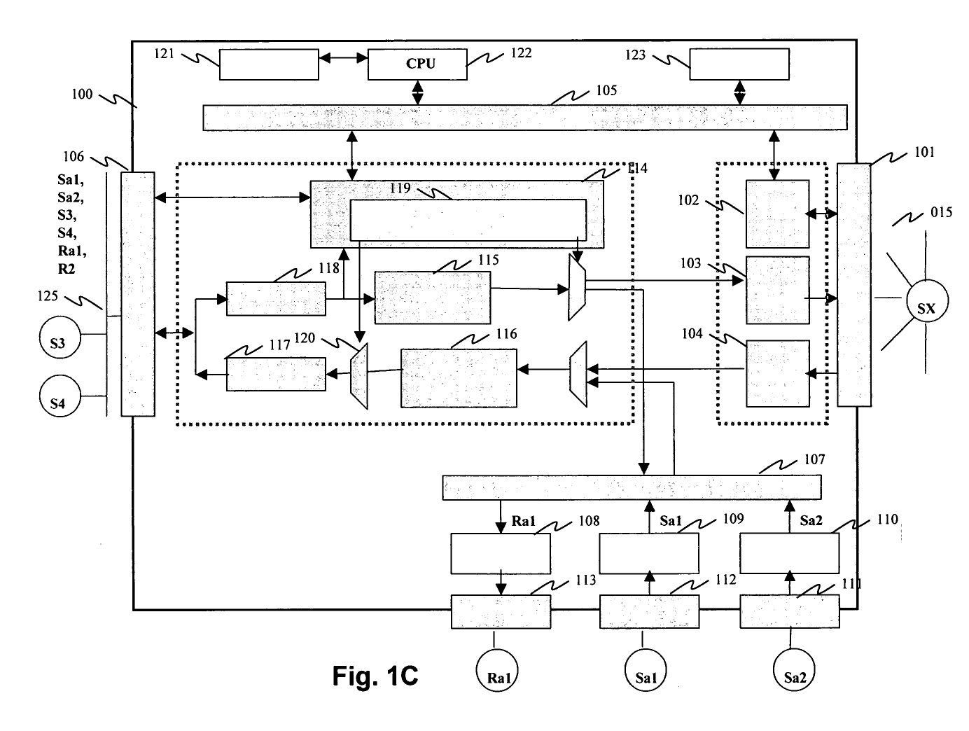

A first embodiment of the access restriction method of the invention is situated in the context of the home network 1000 of FIG. 1A. However, it is clear that the invention can be implemented in any communications network comprising at least one storage unit, storing at least one content, linked to at least one sink device.

Furthermore, hereinafter only the content protection protocol implemented in the home network 1000 shall be considered to be the above-mentioned DTCP protocol. However, it is clear that the invention can also be applied to any content protection protocol comprising a preliminary authentication phase.

By way of an example, it is assumed here below that the content c0, with restricted access in the network, is stored in the storage unit 006 connected to the node NA (hereinafter called a sink node NA). It is also assumed that a user wishes to access this content c0 by reading it on the digital television set 009 (also known as the requesting device) connected to the node NB (hereinafter called the requesting node NB).

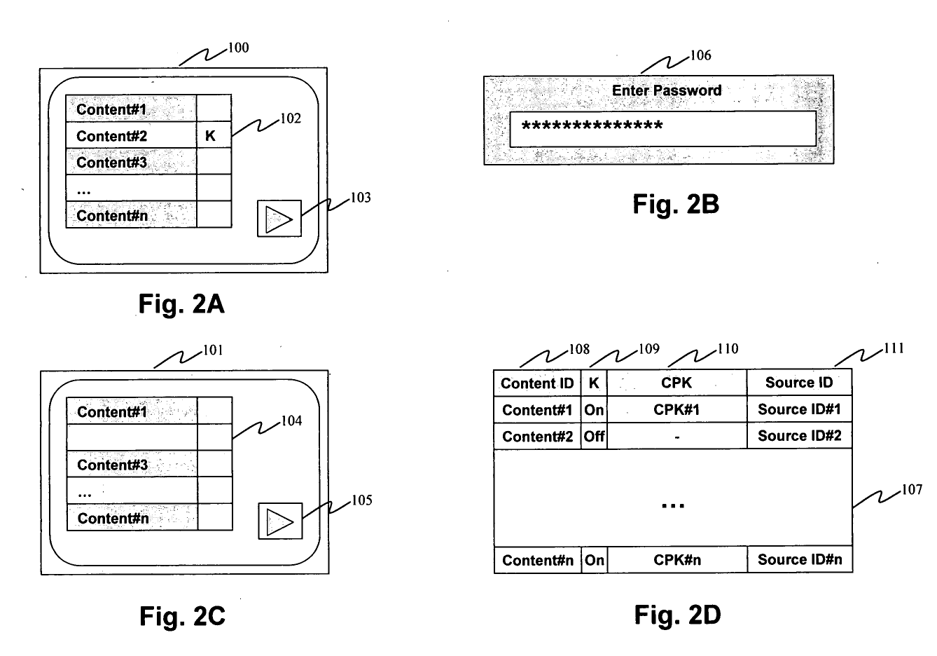

According to a preferred characteristic of the invention, the sink node NA has means to know whether the content c0 is a freely accessible content or restricted-access content. For example, this node may access information in a table providing references to all the contents stored in the network and their access restriction status (defined here below with reference to FIGS. 2A to 2D). Such a table may be the table 107 described here below with reference to FIG. 2D.

The access restriction method according to the invention is implemented in the form of software program and/or a plurality of software programs (comprising a plurality of algorithms described here below) which is (or are) executed in one or more machines of the network 1000, for examples in the node 100 described here below with reference to FIG. 1C.

Referring now to FIG. 1C, a drawing is presented of an implementation of a node 100 of the home network 1000 according to a particular mode of implementation of the invention. For the sake of simplicity, the description is limited to this generic node 100 which represents the node 003 as well as the node 004 and even the node 005 of the home network 1000 of FIG. 1A.

The node 100 is connected all at once to:
the backbone network 1001 (the central switching unit 015 of which is shown in this FIG. 1C) through a digital link,
an IEEE-1394 bus 135 which may be connected to a storage unit; and
analog terminal devices referenced Ra1, Sa1 and Sa2 through analog links.

The node 100 has a backbone interface network 101 with the backbone network 1001 used by the home network controller 102 in order to transmit and/or receive packets to and/or from the backbone network 1001. The backbone network controller 102 also manages the format of these packets.

The node 100 has a transmission buffer memory (or transmit buffer) 103 implemented for data transmission on the network and a reception buffer memory (or receive buffer) 104 for the reception of data coming from the network.

A microprocessor interface module 105 is responsible for interfacing with the microprocessor (referenced CPU or central processing unit) 121 in order to decode the CPU register and carry out DMA (direct memory access) transfers managed by the microprocessor 122 from or to the SDRAM (synchronous dual random-access memory) block 121.

A serial bus interface module 106 provides the interfaces between the physical layer and the link layer of the IEEE-1394 bus in compliance with the IEEE-1394 standard.

An audio-video interface module 107 carries out the formatting (assembling) and unformatting (disassembling) of the IEEE-1394 stream packets sent on the IEEE bus according to the recommendations of the following reference document: “IEC Std 61883, Consumer audio/video equipment—Digital interface”.

The node 100 also includes MPEG2 decoders/encoders 108, 109, 110 respectively connected to audio-video input/output ports 113, 112 and 111 which are themselves connected respectively to the analog terminals Ra1, Sa1 and Sa2.

A transmission control module 114 performs:

all the time-critical operations associated with the IEEE-1394 bridge portal (as described in the following reference document: “IEEE P1394.1 Draft 0.15 Standard for High Performance Serial Bus Bridges”) including especially:
the monitoring of the incoming packets;
the generation of acknowledgement (ACK) messages;
the management of isochronous and asynchronous routing;
the synchronization of the IEEE-1394 clock;

the management of requests for isochronous transfer between:
the serial bus interface 106 and the backbone network interface 101;
the serial bus interface 106 and the microprocessor interface 105;

the following operations on the stream headers when necessary:
elimination;
insertion requests;
timestamping;

the reception of all the interface signals related to the status and interrupt signals from the serial bus interface 106;

the reception of all the interface signals related to the PHY (physical) register access interface signals from the serial bus interface 106.

the management of the transmission and reception of the packets of the contents;

The node 100 comprises a decryption module 115 that implements the decryption of certain contents when authorized to do so.

It includes an encryption module 116 that encrypts certain contents when requested to do so.

It has an isochronous transmission FIFO (“First in First out”) module 117 which implements a 2 K×32 bit asynchronous FIFO operation.

It has an isochronous reception FIFO module 118 which implements a 2 K×32 bit asynchronous FIFO operation.

It has an authentication control module 119 that generates and transmits parameters to a mask function module 120.

The mask function module 120 applies a specific mask function to the data received from the encryption module 116, the mask function depending on parameters provided by the authentication control module 119. The mask function may modify the data according to the parameters provided by the authentication control module 119.

The node 100 also has a flash memory block 123 connected to the microprocessor interface module 105.

Referring to FIGS. 2A to 2D, two examples are presented of embodiments of the user graphic interface implemented in the first preferred embodiment of the access restriction method of the invention as well as in a second particular embodiment which shall be described here below.

In a first example of an embodiment, a first user interface 100 (FIG. 2A) provides a user with a screen display of a list of names of contents referenced content#1, content#2, content#3, . . . , content#n. Each content has an associated piece of information, in a column 102, informing the user whether the content has an associated private content key (referenced CPK) forming a reference password, thus indicating that the content is a restricted access content.

In this first example of an embodiment, each restricted access content stored in the network has a corresponding private content key (referenced CPK) forming a reference password. This information is either “On” when the content is a restricted access content, or is an absence of a character, when the content is not a restricted access content.

When a user wishes to access a restricted access content, he must select the name of the content that he wishes to access from the list of the interface 100, and then select the read or play command 103.

Then a window 106 is displayed to the user (FIG. 2B), inviting him to enter a password that is his own, hereinafter called a user content private key (referenced UCPK).

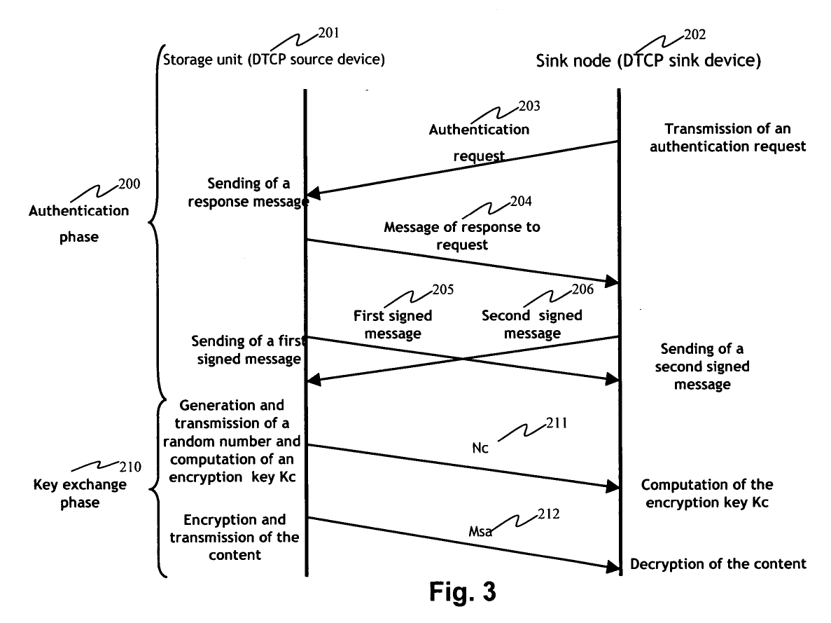

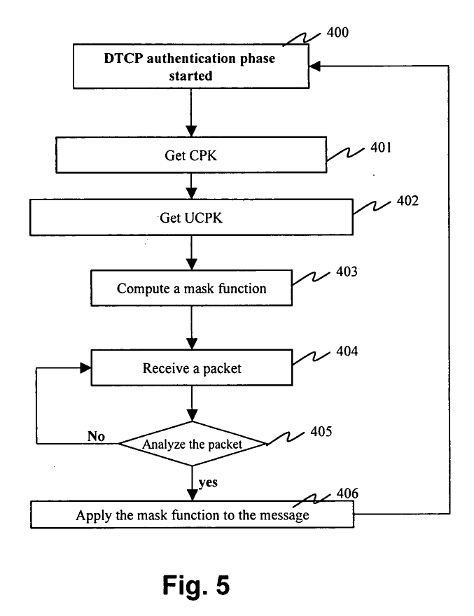

As explained in detail here below, with reference to FIGS. 3 and 5, in particular, if the entered password is identical to the reference password, the user is permitted to have access to the content.

According to a second example of an embodiment, for each content of the network a second user interface 101 (FIG. 2C) provides a user with a screen display of a list of names of contents referenced content#1, content#3, . . . , content#n.

In this second example, if the content is a restricted access content, its name is not displayed to the user nor, in particular, is any information is displayed on the restriction of access to each content in a column 104.

In this second example of an embodiment, the set of restricted access contents stored in the network has a corresponding unique private content key (referenced CPK) forming a reference password.

When a user wishes to access a restricted access content, he must select the play command 105 without having first selected any content name in the list of the interface 101.

Then, a window 106 (FIG. 2B) is displayed to the user, inviting him to enter a password that is his own, which shall hereinafter be called a user content private key (UCPK).

If the user has entered a correct password, a list of the contents that he is authorized to access is displayed to him, and all he has to do then is to select the content that he wishes to read.

FIG. 2D shows a table 107 of the contents and associated access restrictions. This table 107 has all the contents stored in the network 1000 as well as, for each of the contents, a piece of information indicating whether or not it is a restricted access content. Here below, this piece of information shall be called the status of restriction of access to the content.

The content of this table 107 is used by the first and second user interfaces 100, 101 (see FIGS. 2A and 2C).

This table 107 has a first column 108 having the name of each content (contentID), a second column 109 comprising the access restriction status (K) of each content, a third column 110 containing the content private key (CPK) of each content as well as a fourth column 111 comprising an identifier (storagelD) of the storage unit in which each content is stored.

The access restriction status takes the value “on” if the content is a restricted access content and “off” if not.

This table 107 is filled during a preliminary phase of configuration of the network by a user.

According to one variant of these two examples of embodiments of the user interface, it is not the restricted access contents but the storage units on which these restricted access contents are stored that have an associated content private key (CPK).

For example, each storage unit may have a distinct private key associated with it. In another example, a same private key is associated with the all or with only one part of the storage units.

In order that the user may be able to read the content c0 on the digital television set 009, it is necessary first of all of the content c0 should be transmitted from the storage unit 006 to the sink node NA. Once the content c0 is transmitted to the node NA, the transmission of the content c0 from the sink node NA to the digital television set 009 is implemented by means of the classic DTCP protocol or by any other technique (known to those skilled in the art) for securing the transmission of a stream in a communications network.

FIG. 3 provides an illustration, in the above-mentioned context of the transmission of the content c0 from the storage unit 006 to the sink node NA, of the first preferred embodiment of the access restriction method according to the invention relying on the prior-art DTCP protection protocol.

The classic DTCP protocol comprises an authentication phase 200 between the source device 201 and the sink device 202 (which are respectively, the storage unit 006 and the sink node NA in the above-mentioned context).

This authentication phase 200 comprises the following steps:
in a first step, the sink node NA transmits an authentication request 203 to the storage unit 006;
in a second step, the storage unit sends the node NA a message of response to the authentication request 204;

in a third step:
the storage unit 006 sends the node NA a first signed message 205 comprising information specific to the DTCP protocol which the sink node NA verifies to authenticate the storage unit 006;
the node NA sends the storage unit 006 a second signed message 206 comprising information specific to the DTCP protocol which the storage unit 006 verifies to authenticate the sink node NA.

The classic DTCP protocol also has a phase 210 for exchanging keys between the storage unit 006 and the sink node Na.

This key-exchange phase 210 comprises the following steps:
in a fourth step, the storage unit generates a piece of random information, for example a random number 211 (referenced NC) which it sends to the sink node NA, and computes an encryption key Kc which depends especially on this random number NC;
in a fifth step, the sink node NA computes the encryption key Kc by means of the random number NC;
in a sixth step, the storage unit 006 encrypts the content c0 by means of the encryption key Kc so as to obtain an encrypted content 212 (referenced Msa), the storage unit 006 sends the encrypted content Msa to the sink node NA;
in a seventh step, the sink node NA decrypts the encrypted key Msa by means of the encryption key Kc.

As described here below with reference to FIG. 5, it is at the above-mentioned third step that the access-restriction method, according to a preferred embodiment of the invention, tampers with or corrupts (if necessary) the classic DTCP protocol.

Indeed, a processing function which, in a preferred mode, is a mask function is applied to the second signed message so as to tamper with the data carried by the second message if the user has not accurately authenticated the content c0 or is not authorized to access this content.

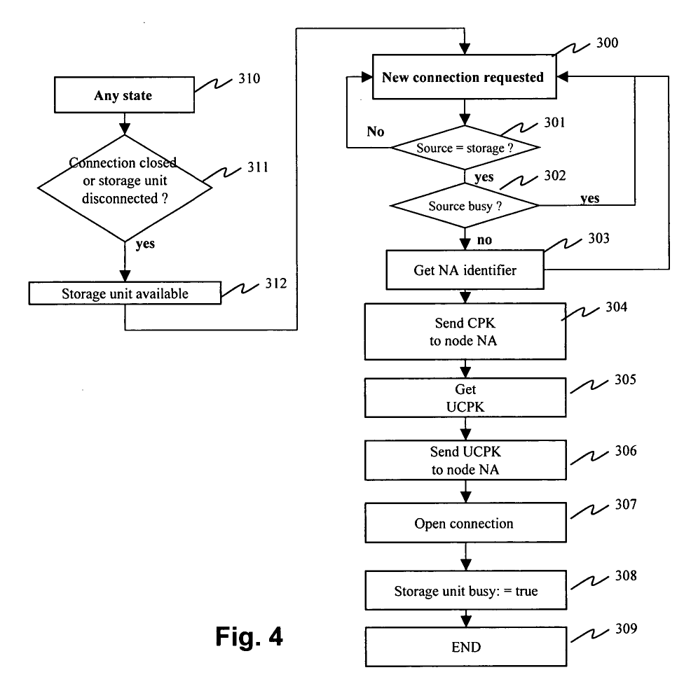

FIG. 4 is a flow chart of a first example of a key-management algorithm, executed by a storage management node which is the node NC, in the first preferred embodiment of the access restriction method according to the invention.

In this embodiment of the invention, the management of the keys is centralized in the node NC, which is the only node of the network to play the role of a node for the management of the storage.

In a first step 300, the connection of a requesting device (for example the digital television set 009) to a source device of the network 1000 is requested, in order to access a content c0. In a second step 301, the storage management node NC checks whether the source device is a storage unit.

If the source device is not a storage unit, the access restriction method is not implemented (but the connection is not rejected), the storage management node NC returns to the first step 300 and waits for a new connection to be requested.

If the source device is a storage unit, for example the storage unit 006, then in a third step 302, the storage management node NC verifies that the storage unit 006 is not busy (namely that it is used by other devices of the network 1000 in that such a way that it no longer has any output port available for the read operation).

If the storage unit 006 is busy, then the connection is rejected and the storage management node NC returns to the first step 300.

If not (namely if at least one output read port is available) then, in a fourth step 303, the storage management node NC obtains an identifier of the sink node NA to which the storage unit 006 is connected.

In a fifth step 304, the content private key (CPK) associated with the content c0 is sent to the sink node NA. At the same time, in a sixth step 305, the user private content key (UCPK) of c0 is obtained (by the entry of a password by the user as described here above with reference to FIG. 2B).

In a seventh step 306, the storage management node NC sends the sink node NA the user content private key (UCPK) of c0.

Then, in an eighth step 307, a connection between the sink node NA and the storage unit 006 is set up and, in a ninth step 308, the storage unit is identified as being busy (if it no longer has any output port available following this connection) or one of its output ports is identified as being busy (if it has at least one output port available following this connection).

Then, the storage management node NC puts an end to this key management process, in a tenth step 309.

At any time (eleventh step 310), if the connection between the storage unit 006 and the sink node NA is closed or if the storage unit 006 is disconnected (a twelfth step 311 seeks to determine if at least one of these conditions is verified), the storage unit 006 is identified as being available (because at least one of these output read reports becomes available) in a thirteenth step 312, if it is still connected. Then, the storage management node NC returns to the first step 300.

This key management and connection management method is implemented for each source device that a requesting device wishes to access, and for each corresponding connection. The node NC herein plays the role of the storage management node.

In practice, and as the case may be, each node NA, NB, NC may play the role of a sink node or requesting node.

In one variant of this first mode of implementation of the invention, the management of keys is not centralized in a specific node but is distributed in every node of the network 1000. In other words, for a transmission of the data content, each node of the network plays its role (sink node or requesting node) and as well as the role of the storage management node. According to this variant, the fourth step 303, fifth step 304 and seventh step 306 of the private key management method are not implemented.

FIG. 5, is a flow chart of an example of a corruption or tampering algorithm of the authentication phase of the DTCP protocol executed by the sink node NA in the first preferred embodiment of the access restriction method according to the invention.

Once the authentication phase of the DTCP protocol has started between the sink node NA and the storage unit 006 in a first step 400, the sink node NA obtains the content private key (CPK), in a second step 401, as well as the user content private key (UCPK) which are associated with the content c0 in a third step 402. These two keys are, for example, given by the storage management node NC, in the above-mentioned centralized management mode.

Then, the sink node NA computes a mask function by means of the private content key (CPK) and the user content private key (UCPK) in a fourth step 403.

Then, the sink node NA waits for the time when it must send the storage unit 006 the second signed message 206 of the third step of the modified DTCP protection protocol (cf. FIG. 3). To do this, at each packet received in a fifth step 404, the node NA analyses the packet in a sixth step 405. If this packet does not correspond to a key authentication and key exchange packet, it re-implements the fifth step 404.

If not, in a sixth step 405, it applies the mask function to the packets of the second signed message 206.

The mask function as defined in such a way that:
if the user content private key (UCPK) associated with the content c0 corresponds to the content private key (CPK) associated with the content c0, the application of the mask function to the packets of the second signed message 206 does not modify these packets;
if the user content private key does not correspond to the content private key (CPK), the application of the mask function to the packets of the second message alters these packets in such a way as to cause the DTCP protocol authentication phase to fail.

Consequently, if the user content private key (UCPK) does not correspond to the content private key (CPK), the authentication of the sink node NA fails and, therefore, the digital television set 009 (or requesting device) cannot have access to the content c0.

However, the connection remains valid if the user wishes to access another unprotected content.

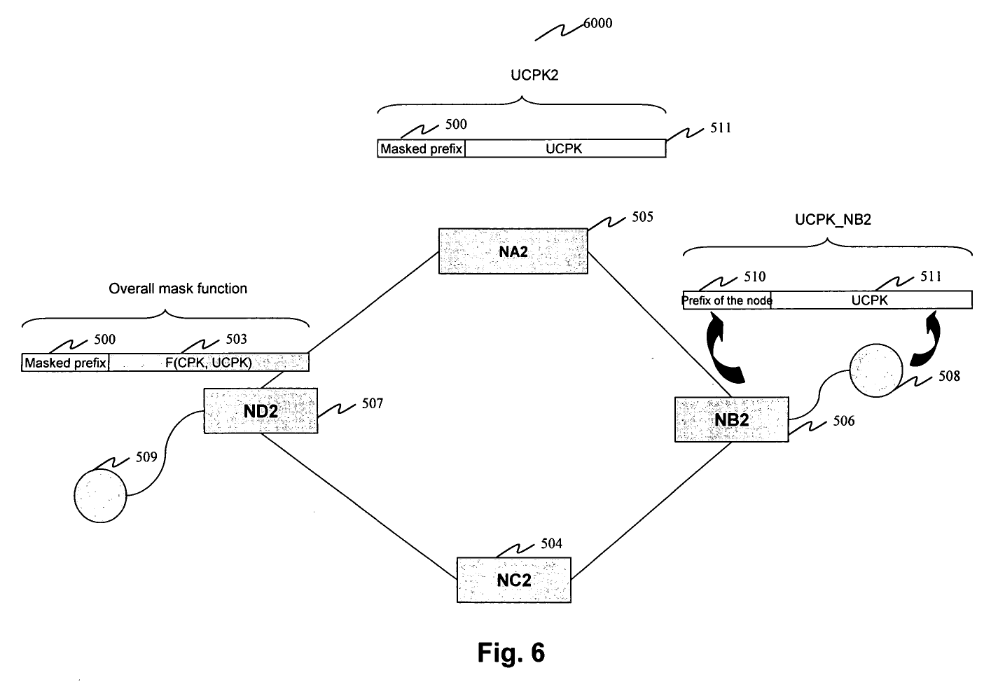

FIG. 6 illustrates the general principle of a second particular embodiment of the access restriction method according to the invention.

This second particular embodiment implements a second level of restriction of access to the stored content.

Here below, the description shall relate to the case where a user wishes to access a content c1, which has restricted access in a network.

According to this second particular embodiment of the invention, the access restriction method is implemented in the form of a software program and/or a plurality of sub-software programs (comprising a plurality of algorithms described here below) which is (are) executed in one or more machines of the network 6000.

In this second embodiment, access is restricted to the content c1 firstly as a function of a password entered by the user (the user content private key UCPK), and secondly as a function of the group to which the node and/or the requesting device belongs.

The description of this second particular embodiment of the access restriction method according to the invention is situated in the context of a home network 6000 presented by FIG. 6 which is identical to the network 1000 of FIG. 1A unless otherwise stated. This network has four nodes, referenced NC2 504, NA2 505, NB2 506 and ND2 507. The node NB2 506, called a requesting node, has a requesting device 508 connected to it. From this requesting device 508, a user wishes to access the content c1 on a source device 509, itself connected to the sink node ND2 507.

In this case, even if the user knows and enters the right user content private key (UCPK), namely the key corresponding to the content private key (CPK) of the content c1, through the user interface, he cannot be authorized to access c1 if the requesting node NB2 (to which the requesting device 508 is connected) is deemed to be unauthorized by the sink node ND2 (to which the source device 509 is connected).

According to a preferred characteristic of the invention, the sink node ND2 includes means to know whether the content c1 has free access or restricted access. For example, it may access information in a table referencing all the contents stored in the network and their access restriction status (defined in relation to FIGS. 2A to 2d). Such a table may be the table 107 described with reference to FIG. 2D.

When a user enters his user content private key (UCPK) 511 through the user interface 106 of FIG. 2B, a node prefix 510, associated with the requesting node NB2 to which the requesting device is connected is added to his user content private key 511 so as to form a piece of information referenced UCPK_NB2.

The node NA2, which plays the role of a storage management node and is hereinafter called a storage management node, obtains both the user content private key (UCPK) 511 of c1 and the node prefix 510.

Then, the storage management node NA2 computes a masked prefix 500 which is a function of the node prefix 510 and of the identifiers of the nodes of the network 6000 which are authorized to access the content c1 through the sink node ND2. The storage management node NA2 builds a new user content private key referenced UCPK2.

Then the storage management node NA2 send the sink node ND2, the new user content private key referenced UCPK2.

When it receives the new user content private key UCPK2, the sink node ND2 computes a new mask function 503 referenced F(CPK, UCPK) in the same way as in the fourth step 403 of the corruption or tampering method of FIG. 5.

The tampering method of FIG. 5 is also implemented in the context of this second embodiment by the sink node ND2. However, the overall mask function which is applied to the packets of the second signed message during the sixth step 405 is the concatenation of the masked prefix 500 and of the new mask function 503.

The overall mask function is defined such that:
if the node prefix 510 is that of a requesting node NB2 authorized to access the content c1 by the sink node ND2;
and if the user content private key 511 corresponds to the content private key of c1;
   then, applying the overall mask function to the packets of the second message does not modify these packets.

If one of these two preceding conditions is not verified, applying the overall mask function to the packets of the second message alters these packets so as to cause the authentication phase of the DTCP protocol to fail.

According to a variant of this second particular embodiment of the access-restriction method according to the invention, it is not the content c1 or a list of contents that the requesting node NB2 is not authorized to access (by the sink node ND2) but the source device 509 itself or a list of source devices.

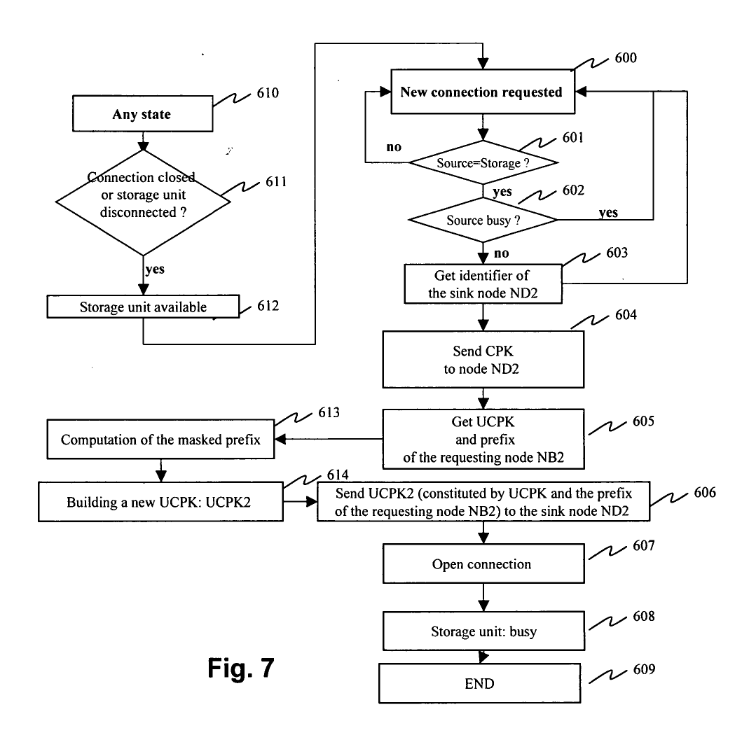

Referring to FIG. 7, we present a preferred mode of implementation, according to the invention, of the content private key management method implemented by the storage management node NA2 according to the above-mentioned second embodiment in which a second level of access restriction to the content c1 is implemented.

Once again, in this mode of implementation of the invention, the management of the keys is centralized, in this case in the node NA2. This node NA2 is the only node of the network to play the role of a storage management node.

In a first step 600, the connection of the requesting device 508 to the source device 509 is requested in order to access the content c1. In a second step 601, the storage management node NA2 verifies that the source device 509 is a storage unit.

If the source device 509 is not a storage unit, the connection is rejected, the storage management node NA2 returns to the first step 600 and waits for a new connection to be requested.

If the source device 509 is a storage unit then, in a third step 602, the storage management node NA2 checks whether the storage unit 509 is not occupied (namely if it is used by other devices of the network 6000 in such a way that had no longer has any output port available for reading).

If the storage unit 509 is busy, then the connection is rejected and the storage management node NA2 returns to the first step 600.

If not (i.e. if at least one output port in read mode is available), then in a fourth step 603, the storage management node NA2 obtains an identifier of the sink node NB2 to which the storage unit 509 is connected.

In a fifth step 604, the content private key (CPK) associated with the content c1 is sent to the sink node ND2. In parallel, in a sixth step 605, the user content private key 511 (UCPK) of c1 is obtained (through the entry of a password by the user as described here above with reference to FIG. 2B).

In this sixth step 605, the node prefix 510 (which is associated with the requesting node NB2 and added to the user content private key (UCPK) 511 so as to form a piece of information referenced UCPK_NB2) is also obtained by the storage management node NA2.

Then, in a seventh step 613, the storage management node NA2 computes the masked prefix 500 from the node prefix 510 and, in an eighth step 614, the storage management node NA2 builds the new user content private key UCPK2 from the masked prefix 500 and the user content private key (UCPK) 511.

In a ninth step 606, the storage management node NA2 sends the new user content private key UCPK2 to the sink node ND2.

Then, in a tenth step 607, a connection between the sink node ND2 and the storage unit 509 is set up and, in an eleventh step 608, the storage unit 509 is identified as being busy (if it no longer has any output port available following this connection) or one of its output ports identified as being busy (if it has at least one output port available following this connection).

Then, the storage management node NA2 finishes this key management method in a twelfth step 609.

At any time (thirteenth step 610), if the connection between the storage unit 509 and the reception node ND2 is closed, or if the storage unit 509 is disconnected (a fourteenth step 611 seeks to determine if at least one of these conditions is verified), the storage unit 509 is identified as being available (because at least one of its read output ports becomes available) in a fifteenth step 612. Then, the storage management node ND2 returns to the first step 600.

In the same way as the first embodiment of the key management method (see FIG. 4), this key management method is implemented for each source device that a requesting device wishes to access, and for each corresponding connection. The node NA2 herein plays the role of the storage management node.

In practice, and as the case may be, each node NA2, NB2, NC2 and ND2 may play the role of a reception node or requesting node.

In one variant of this second mode of implementation of the invention, the key management is distributed in each node of the network 6000. In other words, for data content transmission, each node of the network plays its role (reception node or requesting node) as well as the role of the storage management node. According to this variant, the fourth step 603, fifth step 604 and ninth step 606 of the private key management method are not implemented.

In each of the above two embodiments, a table (not shown) may be implemented in a memory space dedicated to the storage management node (or to each of the nodes of the network in the case of the variant according to which each of the nodes of the network plays the role of a storage management node).

This table, which is obtained for example by a step for the preliminary configuration of the network by a user through a user interface, may include information on the rights of access to the contents stored in the network as well as the requesting nodes or devices authorized to access these contents.

This table could also be the table 107 mentioned here above with reference to FIG. 2D in which information will be added on the rights of access of the requesting nodes or devices of the network.

Thus, when the management of the storage is a centralized management, namely when the network includes only one storage management node, the storage management node can send the sink node a piece of information on the restrictions status of the content that it is sought to access.

A description has been provided of a first embodiment of the invention in which the method for the restriction of access to a content is a function of a user content private key (UCPK) entered by a user, as well as a second embodiment according to which, to the content access restriction as a function of the user content private key, there is added a second access restriction level in which, in addition, access to content is restricted to certain requesting nodes of the network.

Naturally, without departing from the framework of the invention, it is possible to envisage a third embodiment of the invention in which only the second restriction level (restricting access to content to certain requesting nodes of the network) is implemented.

It is clear that many other embodiments of the invention can be envisaged. It can be planned especially that, instead of associating a private key with a content, a private key can be associated with each storage device of the network. Thus, in such a case, a user private key will enable access no longer to a content but rather to all the contents stored in the storage device with which it is associated.

What is claimed is:

1. A method for the restriction of access from a sink device to a content stored in a storage device, a content protection protocol comprising an authentication phase and an encryption key exchange phase being implemented between the storage device and the sink device, wherein the method comprises a prior step for the association of at least one predetermined password with at least one of said content and said storage device; and the following steps of:
a) obtaining at least one piece of access information during the authentication phase;
b) obtaining a processing function dependent on said at least one piece of access information and said at least one predetermined password;
c) applying the processing function thus obtained during the authentication phase of the protection protocol, the application of the processing function causing the authentication phase to fail when said at least one piece of access information does not meet a predetermined access condition.

2. A method according to claim 1, wherein the application of the processing function is done during the exchange of a message from the sink device to the storage device, the message being tampered with if said at least one piece of access information does not meet a predetermined condition.

3. A method according to claim 1 wherein said at least one predetermined password is associated solely with at least one of said content and solely with said storage device.

4. A method according to claim 1, wherein said at least one predetermined password is associated with at least one of:
a plurality of contents, to which said content belongs, and
a plurality of storage devices, to which said storage device belongs.

5. A method according to claim 1, wherein said at least one piece of access information is a user password.

6. A method according to claim 5, wherein said predetermined access condition is a correspondence between the user password and the predetermined password.

7. A method according to claim 1, comprising the following preliminary step:
the association of a first group of authorized devices, comprising at least one device authorized to access at least one of said content and said storage device;
wherein said at least one predetermined access condition is the identifier of the sink device.

8. A method according to claim 7, wherein said predetermined access condition is the membership of said sink device in said first group of authorized devices.

9. A method according to claim 7, wherein said at least one piece of access information is a user password and wherein said predetermined access condition is both the membership of said sink device in said first group of authorized devices and a correspondence between the user password and the predetermined password.

10. A method according to claim 1, wherein said sink device is an intermediate sink device forming a first node by which said storage device is connected to a communications network, a final requesting device is connected to said network through a second node, and the access to the content stored in the storage device is requested by said final requesting device, through said first and second nodes.

11. A sink device enabling access to a content stored in a storage device, said sink device and said storage device comprising means to implement a content protection protocol, comprising an authentication phase and an encryption key exchange phase, said sink device comprising:
means to obtain at least one piece of access information during the authentication phase;
means to obtain a processing function dependent on said at least one piece of access information and at least one predetermined password preliminarily associated with said content and/or said storage device, and
means to apply the processing function thus obtained during the authentication phase of the protection protocol, the means for the application of the processing function causing the authentication phase to fail when said at least one piece of access information does not meet a predetermined access condition.

12. A device according to claim 12, wherein said means for the application of the processing function are activated during the exchange of a message between the sink device and the storage device, the message being tampered with if at least one piece of access information does not meet a predetermined access condition.

13. A device according to claim 12, wherein said at least one predetermined password is associated solely with at least one of said content and said storage device.

14. A device according to claim 12, wherein said at least one predetermined password is associated with at least one of:
a plurality of contents, to which said content belongs, and
a plurality of storage devices, to which said storage device belongs.

15. A device according to claim 12, wherein said at least one piece of access information is a user password.

16. A device according to claim 15, wherein said predetermined access condition is a correspondence between the user password and the predetermined password.

17. A device according to claim 12, comprising:
means for the association of a first group of authorized devices, comprising at least one device authorized to access at least one of said content and said storage device;
wherein said at least one predetermined access condition is the identifier of the sink device.

18. A device according to claim 17, wherein said predetermined access condition is the membership of said sink device in said first group of authorized devices.

19. A device according to claim 17, wherein said at least one piece of access information is a user password and wherein said predetermined access condition is both the membership of said sink device in said first group of authorized devices and a correspondence between the user password and the predetermined password.

20. A device according to claim 12, comprising an intermediate sink device forming a first node by which said storage device is connected to a communications network, wherein the sink device comprises means of communication with a second node by which a final requesting device is connected to said network, so that the access to the content stored in the storage device is requested by said final requesting device through said first and second nodes.
